(19) United States
(12) Patent Application Publication
(10) Pub. No.: US 2020/0311791 A1
(43) Pub. Date: Oct. 1, 2020

(54) SYSTEM AND METHOD FOR ASSISTING IN NEGOTIATIONS FOR COMMERCIAL TRANSACTIONS

(71) Applicant: Zycus Infotech Pvt. Ltd., Mumbai (IN)

(72) Inventors: Vijesh Bhaktha, Mumbai (IN); Bikash Mohanty, Mumbai (IN)

(73) Assignee: Zycus Infotech Pvt. Ltd., Mumbai (IN)

(21) Appl. No.: 16/810,503

(22) Filed: Mar. 5, 2020

(30) Foreign Application Priority Data
Mar. 28, 2019 (IN) 201921012224

(51) Int. Cl. G06Q 30/06; G06F 40/35; G06Q 50/18

(52) U.S. Cl. CPC G06Q 30/0611; G06Q 50/188; G06F 40/35

(57) ABSTRACT

A system and method for assisting in negotiations for commercial transactions is described. This computer implemented system and method assists in negotiations with multiple negotiating parties on various parameters to collaboratively come to a conclusion beneficial to the Buyer organization during sourcing event. The system begins by receiving a quote from a negotiating party in the form of a message on a device. The system then prepares to initiate the negotiation response suitable for a particular negotiating party based on various operating parameters such as time parameters, sentiment parameters, item and price parameters, culture parameters and also negotiating party database. Based on all these parameters, the systems prepares a counter negotiation response which is sent to the negotiating party on behalf of the buyer and negotiating party further responds to the message. It provides productive, adaptive, secure and efficient negotiation skills for conducting commercial transactions.

### CROSS-REFERENCE TO RELATED APPLICATION

The instant application claims priority to Indian Patent Application Serial No. 201921012224, filed Mar. 28, 2019, pending, the entire specification of which is expressly incorporated herein by reference.

### FIELD OF THE INVENTION

The present invention relates to a system and method for assisting in negotiations for commercial transactions.

### BACKGROUND OF THE INVENTION

The emergence of the Internet has caused a shift in the methods of commercial activity towards automated purchasing, marketing, sales and distribution of products, services and bundles. The automated aspects of electronic commerce allow a one-to-one relationship between seller and buyer as compared with the traditional mass production and sales approach. However, most electronic commerce sales systems resemble simple catalog sales or intermediated exchange: neither of these main approaches satisfies the ideal of automated commerce.

Intelligent agent computer programs, also referred to as intelligent agents, software agents or simply agents, have become very popular in recent years. Simply put, agents may be considered to be software-implemented personal assistants with authority delegated from their users. Each agent is a computer program that, in appropriate circumstances, simulates a human relationship by performing something for a person that another person might otherwise do.

These human-delegated software entities can perform a variety of tasks for their human masters. They have been successfully used in helping people with time-consuming activities such as automating repetitive tasks or filtering information. Other conventional uses of intelligent agents include network management, mobile access management, messaging, adaptive user interfaces, etc.

One of the promising areas of application for intelligent systems is negotiation. Adding negotiation capability to an intelligent system is a challenging task. Negotiation is a form of decision-making where two or more parties jointly search a space of possible solutions with the goal of reaching a consensus.

Of the multitude of potential uses of intelligent systems with negotiation capabilities, electronic commerce is one of the most important. The traditional activity for buying and selling in its known forms, business-to-business, business-to-customer, or customer-to-customer, is time-consuming and often includes steps such as negotiating on price and other features. The effective use of software systems negotiating in electronic market places can dramatically reduce the transaction costs for all involved in electronic commerce. For example, dynamically negotiating a price instead of fixing it relieves the seller from needing to determine the value of the good a priori; negotiation pushes this burden into the marketplace itself. Another benefit of negotiation is that limited resources are allocated fairly—to those buyers who value them most.

### OBJECTS OF THE INVENTION

The object of the present invention is to provide a system having productive, adaptive, secure and efficient negotiation skills for conducting commercial transactions on behalf of a client.

Another object of the present invention is to provide a system and a method of negotiating therewith which utilizes one or more features, alone or in combination, to enhance the productivity, security, efficiency and responsiveness of the system in negotiations with other parties.

### SUMMARY OF THE INVENTION

Before the present invention is described, it is to be understood that the present invention is not limited to specific methodologies and materials described, as these may vary as per the person skilled in the art. It is also to be understood that the terminology used in the description is for the purpose of describing the particular embodiments only and is not intended to limit the scope of the present invention.

The present invention describes a system having productive, adaptive, secure and efficient negotiation skills for conducting commercial transactions on behalf of a client. The system assists in negotiations with multiple negotiating parties on various parameters to collaboratively come to a conclusion beneficial to the Buyer organization during sourcing event. The system begins by receiving a quote from a negotiating party in the form of a message on a device or a portal. The system then prepares to initiate the negotiation response. There are various operating parameters based on which the system prepares a negotiation response suitable for the particular negotiating party such as time parameters, sentiment parameters, item and price parameters, culture parameters and also negotiating party database. Based on all these parameters, the systems prepares a counter negotiation response which is sent to the negotiating party on behalf of the buyer and negotiating party further responds to the message.

### DETAILED DESCRIPTION OF THE INVENTION

The system described in the present invention assists in negotiations with multiple negotiating parties on various parameters to collaboratively come to a conclusion beneficial to the Buyer organization during sourcing event. Sourcing event is conducted for procuring item or services. For procuring any item or services an event is scheduled, meaning that the requirements in form of questionnaire are floated to invited negotiating parties within that computer application and such request for quotation or request for information are part of that event.

The system negotiates with multiple negotiating parties in the same manner as it would do with a single negotiating party. The system is also capable of comparing responses of one negotiating party with the other negotiating party and accordingly it can screen the negotiating parties until the system finalizes and selects top two for final negotiation.

In the given embodiment of the present invention, the system begins by receiving a quote from a negotiating party in the form of a message on a device or a portal. The device can be a mobile device, a computer or any other handheld device. The system then prepares to initiate the negotiation response. There are various operating parameters based on which the system prepares a negotiation response suitable for the particular negotiating party.

In the given embodiment of the present invention, these parameters are broadly classified into time parameters, sentiment parameters, item and price parameters, culture parameters and also negotiating party database. Time parameters mostly include parameters like urgency, uncertainty and delay and time zone parameters. Time parameters are important in drafting the negotiation response. In a scenario, where the negotiating party submits a quotation with his price and the quotation meets the permitted price range for acceptance in the system, the system does not immediately provide a negotiation response or acceptance. However, the system maintains a predetermined time gap for exchanging responses. Similarly the systems understand the time gap to assess if the negotiating party is eager to finalize the negotiation or not interested to reduce price by assessing the time gap in negotiating party's responses.

When using the sentiment parameter as the operating parameter for negotiation response, the system interprets certain phrases or words mentioned in the messages received by the negotiating party. In the present embodiment of the invention, the system selects and notes words and phrases like “thank you”, ‘allowing us”, “budgetary”, “conversation”, etc. To these words and phrases various other synonyms are pre mapped in the system. When these words or phrase are noted by the system, the system is trained to understand that these words along with any other pre mapped phrases or words are associated with a particular sentiment or emotion on the negotiating party end. The phrases “thank you” and “for allowing” are noted by the system and it associates them with the sentiment or emotion of “desire/willingness to negotiate on the particular activity and accordingly the system understands that the negotiating party is willing to negotiate further.

Based on the emotions and sentiments assessed by the system, the system then mimics corresponding emotions by way of responses to the negotiating party. The system can mimic emotions such as anger, complain, nonchalant or surprise. The system then according to the analysis devises a mimic negotiation strategy. For example, in the given embodiment, if the system analyses that the negotiating party is showing the desire or willingness to negotiate based on the selected words or phrases, then the system is mapped to demonstrate counter emotion to that negotiating party as nonchalant. The strategy is either to accept the quotation from the negotiating party or to have a neutral response or to negotiate more aggressively or to simply decline or reject the offer or quotation.

The system also considers the time or duration parameters while assessing and analysing the emotions or sentiments of the negotiating party and also while proposing counter emotions and responses. The system employs the mimic time delay strategy to decide the time delay in responding back to the negotiating party. It also decides whether to wait or not for any post contact new response.

While preparing a counter response for a negotiating party for a particular quotation, their past invoices, past communication history as well as external feed from social media and internet is considered under sentiment parameters.

The given embodiment of the invention also consists of a negotiating party database and based on the list there are incumbent and preferred negotiating parties selected by the system for future negotiations. The negotiating party database consists of existing negotiating parties and the rates at which they have offered or supplied goods or services in the past. The system then analyses the last price for the given item procured from the selected/given negotiating party.

Based on all these parameters, the systems prepares a counter negotiation response which is sent to the negotiating party on behalf of the buyer and negotiating party further responds to the message. One or more operating parameters of the system may be constrained to an extent to limit unproductive negotiations, typically based upon the duration of the negotiations and/or the behavior of the other negotiating parties to the negotiations.

The disclosure has been described with reference to the accompanying embodiments which do not limit the scope and ambit of the disclosure. The description provided is purely by way of example and illustration.

The embodiments herein above and the various features and advantageous details thereof are explained with reference to the non-limiting embodiments in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of files, acts, materials, devices, articles or the like that has been included in this specification is solely for providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A computer implemented system for assisting in negotiations for commercial transactions, comprising the steps of:
generating and submitting a requirement to multiple negotiating parties;
receiving a quotation from at least one negotiating party;
upon receiving the quotation, initiating a negotiation response; and
generating the negotiation response based on the analysis of at least one operating parameters selected from time, sentiment, item and price, culture and negotiating party database.

2. The system as claimed in claim 1, wherein said system compares the quotation received from one negotiation party with the quotation received from other negotiating parties to determine the two most suitable quotations for said requirement.

3. The system as claimed in claim 1, wherein the time parameters are at least one selected from urgency, uncertainty and delay and time zone parameters.

4. The system as claimed in claim 1, wherein when the negotiating party submits the quotation and the quotation meets the permitted price range for acceptance in the system, the system provides at least one option selected from negotiation response or acceptance after maintaining a predetermined time gap for exchanging responses.

5. The system as claimed in claim 1, wherein the system uses the sentiment parameter as the operating parameter for negotiation response by interpreting phrases and words mentioned in the messages received by the negotiating party.

6. The system as claimed in claim 5, wherein said words and phrases and their synonyms are pre mapped in the system.

7. The system as claimed in claim 5, wherein the system notes said words and phrases and associates these words along with pre mapped phrases and words with at least sentiment or emotion on the negotiating party end.

8. The system as claimed in claim 7, wherein the system notes the phrases “thank you” and “for allowing” and associates them with the sentiment or emotion of “desire/willingness to negotiate on the particular activity and accordingly the system understands that the negotiating party is willing to negotiate further.

9. The system as claimed in claim 8, wherein the system mimics corresponding emotions based on the emotions and sentiments assessed by the system by way of responses to the negotiation party.

10. The system as claimed in claim 9, wherein the system mimics at least one emotion selected from anger, complain, nonchalant and surprise.

10. The system as claimed in claim 10, wherein the system analyses that the negotiating party is showing the desire or willingness to negotiate based on the selected words or phrases and the system demonstrates the counter emotion to that negotiating party as nonchalant.

11. The system as claimed in claim 11, wherein the final strategy of the system is at least one selected from: to accept the quotation from the negotiating party, to have a neutral response, to negotiate more aggressively and to decline/reject the quotation.

12. The system as claimed in claim 1, wherein the negotiating party database consists of existing negotiating parties and the rates at which they have offered or supplied goods or services in the past and the system selects incumbent and preferred negotiating parties selected for future negotiations.

13. The system as claimed in claim 1, wherein at least one of the operating parameters of the system are constrained to an extent to limit unproductive negotiations, typically based upon the duration of the negotiations and the behavior of the other negotiating parties to the negotiations.
